(19) United States
(12) Patent Application Publication
(10) Pub. No.: US 2025/0389582 A1
(43) Pub. Date: Dec. 25, 2025

(54) METHOD AND DEVICE FOR ESTABLISHING SPECTRUM

(71) Applicant: CAMBRIDGE UNIVERSITY NANJING CENTRE OF TECHNOLOGY AND INNOVATION CO., LTD., Nanjing, Jiangsu (CN)

(72) Inventors: Lei TIAN, Nanjing (CN); Jiewen NIE, Nanjing (CN); Haining YANG, Nanjing (CN); Daping CHU, Cambridge (GB)

(73) Assignee: CAMBRIDGE UNIVERSITY NANJING CENTRE OF TECHNOLOGY AND INNOVATION CO., LTD., Nanjing, Jiangsu (CN)

(21) Appl. No.: 18/879,444

(22) PCT Filed: Oct. 11, 2022
(86) PCT No.: PCT/CN2022/124582

§ 371 Date: Dec. 27, 2024

(30) Foreign Application Priority Data
Jul. 13, 2022 (CN) 202210821376.3

(51) Int. Cl. G01J 3/12; G01J 3/28; G02F 1/1335; G02F 1/137

(52) U.S. Cl. CPC G01J 3/12; G01J 3/2823; G02F 1/133514; G02F 1/137; G01J 2003/1213; G01J 2003/2826

(57) ABSTRACT

A method and device for establishing a spectrum. The device comprises a light source, a micro-nano filter device and a voltage control apparatus; the micro-nano filter device comprises a cover plate and a substrate which is provided with a conductive electrode, a film layer and an electrically controlled phase-change material being located between the substrate and the cover plate; the cover plate and the substrate layer are made of a transparent material, the transparent material having a flat surface, covering a conductive film which comprises an ITO layer, and serving as an electrode of an applied external voltage; nano-structure units arrayed periodically are prepared on the conductive film, the nano-structure units arrayed periodically being made of one of a metal material, a metal oxide material or a semiconductor material.

### TECHNICAL FIELD

The disclosure relates to the technical field of spectral measurement and imaging, and particularly relates to an optical spectrometer based on a filter, and a method for re-establishing or establishing a spectrum.

### BACKGROUND

Since electrons in atoms of different substances move differently, when the substances are illumined by light (including light waves from infrared light waves to ultraviolet light waves), the substances have different spectra which can be used to reflect properties of the substances. Optical information of a plurality of channels of a target object or substance is collected within a continuous light wave range, and a spectrum of the target object or substance is estimated through an algorithm. Such a technology has significant applications in remote sensing, crop monitoring, atmospheric observation and other fields.

According to different light splitting methods, existing spectrum technologies are divided into a chromatic dispersion spectral imaging technology, in which a prism and an optical grating serve as light splitting elements, an optical filter spectral imaging technology and an interference spectral imaging technology. The chromatic dispersion spectral imaging technology has resolution enormously affected by sizes of the light splitting elements, and is high in insertion loss, high in hardware cost and complex in operation. The optical filter spectral imaging technology is divided into two types. One is achieved by designing an optical filter having determined spectral transmittance, and can achieve high spectral resolution with requiring an optical filter array. The other one is achieved by cascading a plurality of optical tunable filters, and is complex in structure, low in transmittance and not conducive to integration.

An interference optical spectrometer obtains spectral information on the basis of Fourier transform, and has high spectral resolution. However, this instrument requires a precise driving mechanism, so a size and weight of the system are largely increased. Moreover, such a system is sensitive to disturbance and poor in stability. These spectral measurement and reconstruction technologies hinder high resolution and low cost of detection by an optical spectrometer within a broadband range.

CN 108885365 B/U.S. Pat. No. 10,514,573 provides a device for controlling an electromagnetic wave. The device may include a first electrode layer. The device may further include a second electrode layer. The device may further include a matrix layer located between the first electrode layer and the second electrode layer. The matrix layer may include a liquid crystal layer. The matrix layer may further include at least one resonant element in contact with the liquid crystal layer. The liquid crystal layer may be configured to switch at least from a first state to a second state in response to a voltage applied between the first electrode layer and the second electrode layer so that optical properties of the matrix layer can be changed, and the electromagnetic wave received by the matrix layer can be controlled.

An existing technical solution related to the disclosure can be obtained with reference to FIG. 1. A schematic diagram of a typical spectral reconstruction and imaging system is shown in FIG. 1. The system includes a reconstruction or imaging target, a light splitting element (a tunable filter, a chromatic dispersion element, an interferometer, etc.), an imaging lens and a detector array. A process is as follows: after the reconstruction or imaging target passes through the light splitting element and then the imaging lens, an image is formed on the detector array. Light, which passes through an optical element, in different wavebands show different properties. Thus, image data in each waveband can be obtained through scanning. Finally, spectral reconstruction is achieved in combination with an algorithm.

In an optical chromatic dispersion spectral imaging method shown in FIG. 2, spectral reconstruction and imaging technologies are mainly divided into a chromatic dispersion type, an optical filtering type and an interference type according to different spectral light splitting methods. An optical grating or prism serves as a light splitting element for an optical spectrometer based on a spatial chromatic dispersion principle, as shown in FIG. 2. After the reconstruction or imaging target is collimated by a collimating system, chromatic dispersion occurs on a light beam due to different diffraction angles of the optical grating to light having different wavelengths or different refraction degrees of the prism to light having different wavelengths. The light having different wavelengths is mapped to a specific spatial position and focused on a detector by a focusing lens.

The optical spectrometer based on an optical filtering principle can be divided into two types. One is as follows: a freely-tunable optical filter is introduced in an imaging optical path, a narrowband image is obtained in each transient state, and a complete spectral data cube is obtained after a plurality of transient states. Common tunable filters include an acousto-optic tunable filter, a liquid crystal tunable filter, a Fabry-Perot filter, etc. The filter is dynamically controlled through a change (electrical, optical or other properties) of an external signal so that different spectral information can be output. The other one is as follows: a spatial anisotropic filter is introduced, and different spectral information can be obtained by designing an optical filter array having determined spectral transmittance.

FIG. 3 shows a spectral imaging structure based on a tunable filter in the prior art. A spectral imaging structure based on a tunable filter is shown in FIG. 3. By adjusting a transmission wavelength of the tunable filter, spectral images having different wavelengths can be obtained. Narrowband light output by the filter is different due to different conditions of controllers.

A spectral imaging structure based on a spatial anisotropic filter is shown in FIG. 4. The reconstruction or imaging target scans different positions of an optical filter array. Different spectral information is obtained due to different transmission properties of different optical filters to light in the same waveband.

FIG. 4 shows a spectral imaging structure based on a spatial anisotropic filter in the prior art. The optical spectrometer based on an interference principle forms stable interference fringes by using coherent light beams having optical path differences and through Fourier transform, and obtains spectral information by using a Fourier transform relation between light wave energy of the interference fringes and a spectrum of polychromatic light. A principle of an interference spectral imager is shown in FIG. 5. A Michelson interferometer is used as an optical splitter. The reconstruction or imaging target is divided into two beams by a beam splitter, that is, a reflected light beam and a transmitted light beam. After being reflected by a static lens and transmitted by the beam splitter, the reflected light beam arrives at the focusing lens. After being reflected by a movable lens and reflected by the beam splitter, the transmitted light beam arrives at the focusing lens. Images of the two light beams on the detector are interference fringes. Spectral intensity of the polychromatic light is solved through inverse Fourier transform.

Advantages and disadvantages of the prior art are as follows: the optical spectrometer in the prior art is also called a spectroscope and a direct-reading optical spectrometer. An apparatus for measuring intensity of spectral lines at positions having different wavelengths by an optical detector such as a photomultiplier tube is provided. The apparatus is composed of an entrance slit, a chromatic dispersion system, an imaging system and one or more exit slits. The spectral imaging technology based on a chromatic dispersion principle is more mature. However, after passing through a chromatic dispersion element and then an image lens, an image of a target object converges into spectral images. Imaging time is long, spectral resolution is extremely affected by a size of the light splitting element, and dependence on a numerical aperture of an optical system is strong. An optical grating system splits light according to a light diffraction principle. An actual energy utilization rate is low, and a plurality of orders of diffraction overlap. A manufacturing process is demanding, and plenty of stray light exists. A prism material splits light by using different refractive indexes for different wavelengths. However, there is no linear relation between a refractive index change and a wavelength, resulting in nonlinear spectral resolution and uneven chromatic dispersion. In addition, spectral line curvature and color distortion are caused.

The tunable filter spectral imaging technology based on an optical filter is continuous in tuning, simple and compact in structure and fast in response speed. However, the tunable filter is formed by cascading a plurality of devices. Thus, transmittance loss is sever, a light energy utilization efficiency is low, and a bandwidth is ultra-narrow. High resolution contradicts a large free spectral range, and application of information contained in a broadband is impeded.

The spectral imaging technology based on a spatial anisotropic filter requires a plurality of spectral optical filters, and is restricted in the number of channels and low in spectral resolution. As a result, practical application is limited.

The spectral imaging technology based on interference has high resolution, and optical elements are precise. However, the size and weight of the system are greater than that of other light splitting elements. Furthermore, this technology is sensitive to disturbance, poor in stability and complex in data processing.

### SUMMARY OF THE INVENTION

An objective of the disclosure is to solve problems and defects in the prior art. A spectral reconstruction or imaging system and method based on a micro-nano filter (structure) is provided so that a filtering property of the filter can be controlled, light wave transmittance data can be controlled and spectral reconstruction or imaging is carried out. Thus, a speed and resolution of spectral reconstruction or imaging are improved, and integration is easy.

A technical solution of the disclosure is as follows: a device for establishing a spectrum includes a light source, a micro-nano filter and a voltage control apparatus. The micro-nano filter includes a substrate and a cover plate. An electrically-conductive film layer and an electrically-controlled phase-change material are arranged between the substrate and the cover plate. The cover plate and the substrate are each made of a transparent material. The transparent material has a flat surface and is covered with the electrically-conductive film layer including an indium tin oxide (ITO) layer, so that an electrode for applying external voltage is formed.

Nano-structure units in a periodic array are manufactured on the electrically-conductive film layer. The nano-structure units are made of one of a metal material, a metal oxide material or a semiconductor material. Distribution of the nano-structure units is determined according to a property of a spectrum to be constructed. The nano-structure units include nano-block distribution structures, optical grating distribution structures or nano-hole distribution structures with a certain length-width-height ratio. Nano-block, optical grating or nano-hole units have a subwavelength size. A transmission spectrum is adjusted and controlled by cooperation between the nano-structure units in the periodic array of the micro-nano filter and the electrically-controlled phase-change material. A voltage is applied to the electrically-controlled phase-change material by the voltage control apparatus.

Nano-block, optical grating or nano-hole units have a subwavelength size, and may have sizes of hundreds of nanometers.

The nano-block is a block made of a metal material, a metal oxide material or a semiconductor material, or a block made of one or more of a metal material, a metal oxide material and a semiconductor material, and has a subwavelength size.

The nano-structures of the micro-nano filtering structure include a hole array, an optical grating, a nano-column array, etc. A transmission spectrum is adjusted and controlled by the micro-nano filtering structure, especially the nano-structure. The hole array or the nano-structure array unit has a structure having a subwavelength size. The nano-blocks made of the metal material, the metal oxide material or the semiconductor material of the nano-structures each have a length, a width and an ellipse size each ranging from 100 nm to 1000 nm. A period is formed by several nano-blocks, and an array is composed of a multi-period range. A channel in the device in the disclosure is formed in time. That is, an optical transmission channel is formed in the device due to different refractive indexes of a liquid crystal. Such periodic distribution exits in the light beam range.

The micro-nano filter or structure is composed of periodic nano-structures made of one or more of a metal material, a metal oxide material or a semiconductor material. A size of a metal block, the metal material, the metal oxide material or the semiconductor material is less than a wavelength. Gold (Au), silver (Ag), aluminum (Al), titanium dioxide (TiO₂), silicon nitride (SiN), gallium nitride (GaN), silicon (Si), germanium (Ge), etc. are included. Specifically, SiO₂ and TiO₂ each have a subwavelength size, and show low absorption in infrared and visible spectral ranges. The electrically-controlled phase-change material is a liquid crystal, graphene, lithium niobate, germanium antimony telluride or vanadium dioxide, which all have transmittance and refractive indexes electrically controlled. Higher transmittance is better, and a larger refractive index range changed by a phase change is better.

Spectral information of a plurality of channels is controlled by periodic nano-structures distributed on a flat surface of a film layer of the micro-nano filter. The nano-structures are formed by a staggered distribution of blocks made of a metal material, a metal oxide material or a semiconductor material. The blocks made of a metal material, a metal oxide material or a semiconductor material each have a length of 200 nm±50 nm and a width of 100 nm±30 nm (sizes of other shapes of the nano-block is also fall within the ranges, such as a diameter of a circle, a maximum straight line length of a cross, and a maximum diameter of an oval). The blocks made of a metal material, a metal oxide material or a semiconductor material of the micro-nano filtering structure has a thickness of 250 nm±100 nm.

The blocks made of a metal material, a metal oxide material or a semiconductor material can be manufactured through coating, masking, photolithography and other etching methods, which is not limited thereto.

The nano-structure units in the periodic array of the micro-nano filter are distributed on a surface of the electrically-conductive film layer on one side corresponding to either of the substrate and the cover plate, or on two sides corresponding to both of the substrate and the cover plate. That is, the nano-structures may be distributed on an ITO surface on one side or ITO surfaces on two sides. The liquid crystal layer is in direct contact with the periodic nano-structures. Moreover, ITO electrically-conductive layers on two sides are connected to a power supply having an adjustable amplitude. In response to a voltage applied between the substrate and the cover plate, the refractive index changes. In addition, resonance of the micro-nano filter or structure changes, so that a filtering property of the device is changed.

The micro-nano filter or structure may be formed by stacking nano-structure materials with various periodicities including nano-blocks having a high refractive index and nano-blocks having a low refractive index and distributed in a staggered manner. Different materials having largely different light transmission properties for light in the same waveband may be selected.

Distribution, a hole structure and length-width-height ratio of the micro-nano filter or structure can be changed according to a required property. A hole array, an optical grating, a nano-column array and a nano-block array are included but do not constitute limitations. Gold, silver, aluminum and titanium nitride are used in an infrared waveband. Germanium and silicon dioxide are used in a visible waveband. Materials and morphology of the micro-nano filter and structure are selected according to a required waveband.

According to a method for establishing a spectrum by using the device, a refractive index of a liquid crystal is controlled by controlling voltages of a substrate 1 and a cover plate 4, or a property of the filter is changed according to distribution of micro-nano filtering structures. a transmittance curve of different wavebands passing through the filter are obtained. Spectral information is solved by using a pseudo-inverse method, etc. according to light-transmission information. An actual refractive index of the liquid crystal material is changed by controlling an intensity of an applied electric field. A resonant frequency for a spectrum of a light source is changed. The spectrum is programmable-filtered. Sizes of micro-nano filtering structures used in different wavebands are different. The morphology of the micro-nano filter can also be changed, but the size of the nano-structure is mainly changed.

The nano-structures can block light, but a period of the nano-structure is less than the wavelength. A traditional geometric optics theory is not used for understanding. As long as a blocking ratio is not extremely large, transmittance is still extremely high. In addition, many dielectric materials also have extremely low absorption in some wavelengths. An actual refractive index of the electrically-controlled phase-change material such as a liquid crystal is changed by adjusting a voltage. Thus, the voltage and the refractive index of the liquid crystal are actually the same variable.

By using a nano-structure array and a tunable material, a property of a material under different controlled conditions is adjusted (which reflects a change of a refractive index of the material). Moreover, information of transmittance of light passing through the device in the disclosure is changed, so that the spectrum is reconstructed.

The blocks made of a metal material, a metal oxide material or a semiconductor material of the nano-structure array each have a length of 200 nm±50 nm and a width of 100 nm #30 nm. The blocks made of a metal material, a metal oxide material or a semiconductor material can be manufactured through coating, masking, photolithography and other etching methods. The blocks made of a metal material, a metal oxide material or a semiconductor material in the nano-structure of the micro-nano filter each have a thickness of 250 nm±100 nm.

The spectrum and distribution can be obtained with further reference to descriptions in CN 108885365 B/U.S. Pat. No. 10,514,573. The nano-structure array has a periodic structure having an equivalent subwavelength size, which can be understood as a resonant element. A resonant frequency thereof is related to a structural configuration and a refractive index of a structural material. In addition, in CN 108885365 B, it is clarified that a liquid crystal material is controlled by an electric field. The liquid crystal material in the disclosure is also required to be adjusted and controlled by an electric field. The liquid crystal material is also required to be adjusted and controlled by an electric field. Various properties of a material under different controlled conditions can be adjusted by using various tunable electrically-controlled phase-change materials including a liquid crystal. Thus, transmittance information of light passing through the device is changed, and further the spectrum is reconstructed. The nano-structure array is a resonant element. The resonant frequency thereof is related to a structural configuration and a refractive index of a structural material of the resonant element. A transmission spectrum of the light is determined by the resonant frequency. The channel in the device in the disclosure is formed by changing a refractive index on time. A channel is formed in the device in cases of different refractive indexes of a liquid crystal. The nano-structure array has the periodic distribution in the light beam range.

According to the method for establishing a spectrum, a refractive index of a liquid crystal is controlled by controlling voltages of a substrate 1 and a cover plate 4, and a property of the filter is changed according to distribution of film layers of micro-nano filtering structures. a transmittance curve of different wavebands passing through the filter are obtained. Spectral information is solved by using a pseudo-inverse method, etc. according to light-transmission information.

Spectral information of a plurality of channels is controlled by periodic nano-structures distributed on a flat surface of a film layer of the micro-nano filter. The nano-structures are formed by a staggered distribution of blocks made of a metal material, a metal oxide material or a semiconductor material. The blocks made of a metal material, a metal oxide material or a semiconductor material each have a length of 200 nm±50 nm and a width of 100 nm±30 nm. The blocks made of a metal material, a metal oxide material or a semiconductor material of the micro-nano filtering structure each have a thickness of 250 nm±100 nm.

A plurality of channels herein mean that a transmission property of a spectrum is controlled by the periodic nano-structures. A plurality of channels are also used to express that the spectrum does not have a single frequency, but can be a continuous spectrum. In an existing spectral imaging technology based on a spatial anisotropic filter, filtering properties of different regions of a color filter are different. A spectrum to be measured is restored by collecting transmission light intensity of the different regions. A region can be understood as a channel. A desirable restoration effect can be achieved generally by 16 or 32 channels. More channels are better in theory, which, however, conflicts with a spatial resolution requirement. It is desirable to achieve a balance between a number of channels and spatial resolution.

In the disclosure, existing channels in space are converted into channels in time. Since changes of refractive indexes of a phase-change material such as a liquid crystal are continuous under the action of an external force, this device becomes a specific channel in cases of different refractive indexes, and countless channels can be achieved in theory. During actual use, better restoration can be achieved by 16 or 32 channels.

A relation between periodic nano-structure distribution and a channel is as follows: periodic nano-block structure distribution is periodically repeated. A spatial period is generally less than or similar to a wavelength of a spectrum to be measured (500 nm to 1500 nm). A material block, a hole or an optical grating may have coverage of 20% to 90%. The nano-blocks may be at least one or more types of rectangles, circles and crosses, which are uniformly distributed and then periodically repeated. In order to demonstrate that the structure given in the disclosure can well reconstruct these 12 types of spectra having different properties, the 12 types of spectra are rectangular nano-blocks which are periodically repeated. However, the method in the disclosure is not limited to these 12 types. A spectrum in any morphology can be reconstructed in theory.

In the disclosure, existing channels in space are converted into channels in time. Since changes of refractive indexes of a phase-change material such as a liquid crystal are continuous under the action of an external force, this device becomes a specific channel in cases of different refractive indexes, and countless channels can be achieved in theory. During actual use, better restoration can be achieved by 16 or 32 channels.

In a spectral filter on the basis of nano-structures in FIG. 6, the micro-nano filter or structure can be distributed on ITO surfaces on two sides separately or simultaneously (as periodic nano-particle lattices composed of media), which is not limited to one side of the substrate.

The nano-structure of the micro-nano filter or structure may be formed by stacking various materials, such as materials having a high refractive index and materials having a low refractive index and distributed in a staggered manner. Different materials having largely different light transmission properties for light in the same waveband can be selected. The materials having a high refractive index and materials having a low refractive index mean that different nano-blocks are manufactured by materials having a high refractive index and materials having a low refractive index, or a nano-block is composed of a plurality of layers of structures, and each layer has a different refractive index.

A width of the periodic nano-structure is generally required to exceed a beam width of the light source.

Distribution, a hole structure, a length-width-height ratio, etc. of a nano-structure of the micro-nano filter or structure can be changed according to a required property. A hole array, an optical grating, a nano-column array, etc. are included but do not constitute limitations.

An optical matrix is affected by a thickness of the nano-structure of the micro-nano filter or structure. Noise immunity is poor when the nano-structure is thinner.

A micro-nano filter or structure composed of nano-structures of various structures and materials is beneficial to improvement of noise immunity.

Gold, silver, aluminum, titanium nitride, etc. are commonly used in an infrared waveband. Germanium, silicon dioxide, etc. are commonly used in a visible waveband. Materials and morphology of the micro-nano filter and structure are selected according to a required waveband.

The liquid crystal layer is in direct contact with the micro-nano filter or structure. Moreover, ITO-class electrically-conductive layers on two sides are connected to a power supply having an adjustable amplitude. In response to a voltage applied between the substrate and the cover plate, the refractive index changes. In addition, resonance of the micro-nano filter or structure changes, so that a filtering property of the device is changed. A voltage required by a change of a liquid crystal state is determined by the thickness of the liquid crystal layer. An electrode may be hot due to a high voltage.

The detector includes a charge-coupled device (CCD) or a complementary metal oxide semiconductor (CMOS), and is used to measure a transmission spectrum of the micro-nano filter or structure. Light waves received by the detector in cases of a plurality of groups of different driving voltages, that is, different liquid crystal refractive indexes, are obtained. The micro-nano filter or structure is dynamically adjustable along with time.

Spectral information is reconstructed on the basis of a plurality of groups of transmittance data of an array of the micro-nano filter. The method may be a least square method, a pseudo-inverse method, a neural network method, etc. Specific steps of reconstructing spectral information through the least squares method are as follows:
in an ideal imaging model, assuming that P(λ) is a spectral power distribution function and F(Δ) is spectral transmittance, obtaining detection power D of an imaging system as D=∫P(λ)F(λ)dλ.

During reconstruction, digitizing P(λ) and F(λ), where m=1, 2,···M is spectral resolution of a reconstruction input signal, n=1, 2,···N is a filter, and

$${D}_{n} = {\sum }_{m = 1}^{M} P ( {λ}_{m} ) {F}_{n} ( {λ}_{m} ) .$$

Thus, after a group of transmittance curves are obtained, a measurement value of an optical spectrometer based on a filter can be expressed as follows: D_{N×1}=S_{N×M}P_{M×1}, where S denotes a matrix composed of transmittance curve groups, P denotes input spectral information, and D denotes a measurement value of the detector corresponding to the filters.

In a case of N<<M, the above formula becomes an underdetermined linear algebra problem, and is translated into: minimize|D-SP∥²(0≤P≤1).

Solution can be carried out through a CVX algorithm. Moreover, S denotes a matrix composed of spectral transmission curve groups of nano-block structure and electrically-controlled phase-change material combined units in the disclosure in cases of different voltage control. A transmittance curve is a result obtained by using a structure and electronically-controlled refractive index of the nano-block.

The disclosure has beneficial effects as follows: the whole process of spectral reconstruction is displayed. A number of filters required for a reconstruction input signal can be far less than a number of channels (channels have transmission spectra in cases of values of refractive indexes). The disclosure is superior to an existing spectrometer in a plurality of aspects such as hardware cost, system operation complexity, and spectrum resolution. It is expected that ideas are provided for achieving an intelligent and miniaturized optical spectrometer. In the disclosure, a transmission curvature property of the filter is a spectral filtering property of the structure, which has a crucial influence on a spectral reconstruction result. The transmittance curve shall cover high-frequency and low-frequency information of a reconstruction signal. A light-splitting property of the filter is changed by changing a parameter of the filter. A transmission curve of light is continuously and finely adjusted. The spectral information is computed by using a pseudo-inverse method. A pre-protection point lies in that the filter is manufactured by a tunable material. Transmittance of different wavebands after a continuous light source passes through a device is changed by controlling a condition. Thus, a solution is provided for miniaturization, high speed and accuracy of a spectral reconstruction system.

### BRIEF DESCRIPTION OF THE DRAWINGS

FIG. 1 is a schematic diagram of a typical spectral reconstruction and imaging system;

FIG. 2 is a schematic diagram of an optical chromatic dispersion spectral imaging method;

FIG. 3 is a schematic diagram of a spectral imaging structure based on a tunable filter according to the prior art;

FIG. 4 is a schematic diagram of a spectral imaging structure based on a spatial anisotropic filter according to the prior art;

FIG. 5 is a schematic diagram of a principle of an interference spectral imager according to the prior art;

FIG. 6 shows a spectral filter structure based on nano-structures according to the disclosure;

FIG. 7 shows a spectral reconstruction system according to the disclosure;

FIG. 8 is a schematic diagram of a hole array structure according to the disclosure, where in FIG. 8, a layer of gold is laid on a substrate, a circular hole is dig on the gold and filled with a liquid crystal, and in this case, a hole array is formed;

FIG. 9 is a top view of a hole array structure (a section, that is, the structure in FIG. 8) according to the disclosure;

FIG. 10 is a schematic diagram of an optical grating structure according to the disclosure;

FIG. 11 is a top view of an optical grating structure (a section) according to the disclosure;

FIG. 12 is a schematic diagram of a nano-block structure according to the disclosure;

FIG. 13 is a top view of a nano-block structure (a section) according to the disclosure;

FIG. 14 is a simulated transmittance curve of a nano-block micro-nano filtering structure according to the disclosure;

In FIG. 15, (a), (b), (c) and (d) show change curves of transmittance along with refractive indexes of a liquid crystal in cases of four different wavelengths (1300 nm, 1400 nm, 1500 nm and 1600 nm) according to the disclosure respectively;

FIG. 16 shows an original spectrum according to the disclosure;

FIG. 17 shows a transmission spectrum after an original spectrum passes through a nano-block micro-nano filtering structure according to the disclosure;

FIG. 18 shows light intensity information after an original spectrum passes through a nano-block micro-nano filtering structure according to the disclosure;

FIG. 19 shows a reconstructed spectrum after light of an original spectrum passes through a nano-block micro-nano filtering structure according to the disclosure;

In FIG. 20, there are 12 reconstructed spectra, that is, 12 reconstructed spectra obtained after a plurality of original spectra according to examples of the disclosure pass through a nano-block micro-nano filtering structure;

FIG. 21 shows that a micro-nano filtering structure is a disk and cross nano-structure array; and

FIG. 22 is a front (top) view of the micro-nano filtering structure in FIG. 21.

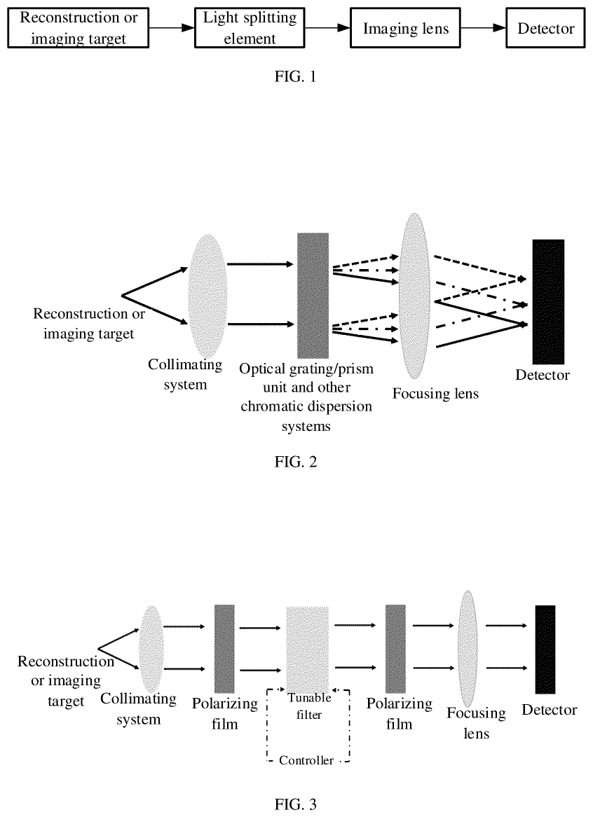

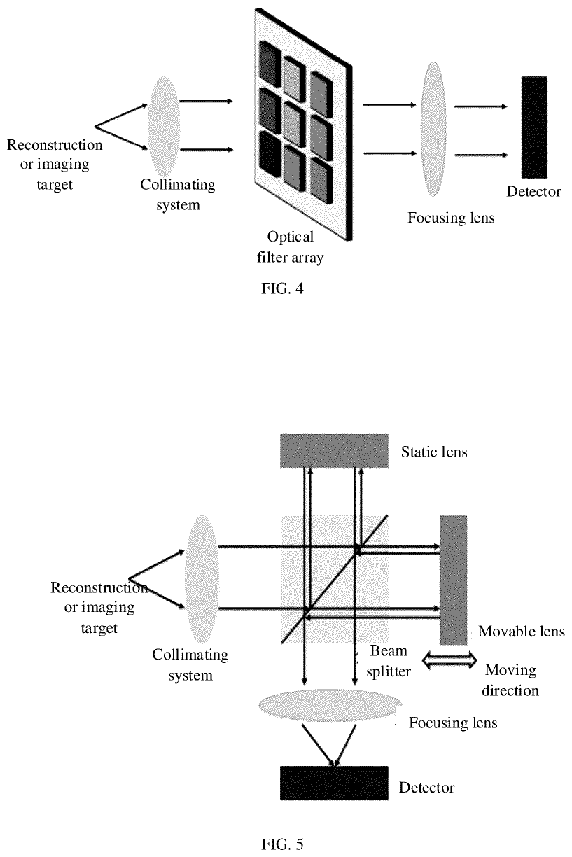

### DETAILED DESCRIPTION

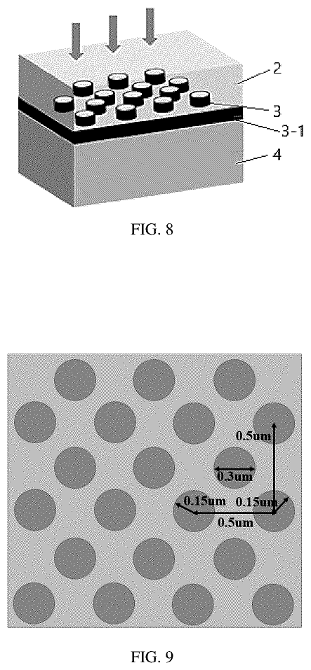

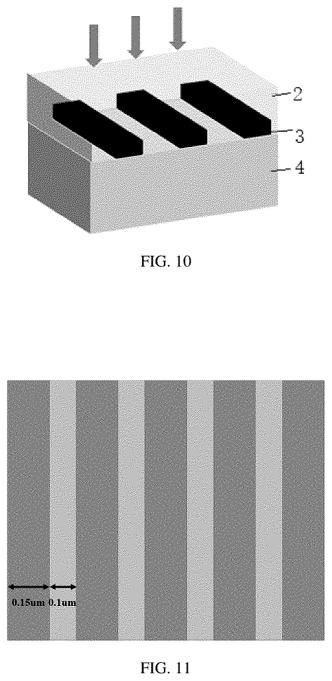

Particular instances are used for description below. A spectral reconstruction system is constructed by using a reconstruction or imaging target, a micro-nano filter or structure, a voltage control module and a detector as main units. As shown in FIG. 7, a light source, a micro-nano filter and a voltage control apparatus are arranged. The micro-nano filter includes a substrate 4 and a cover plate 1 which are provided with electrically-conductive electrodes, and a film layer and an electrically-controlled phase-change material which are arranged between the substrate 4 and the cover plate. The cover plate and the substrate layer are made of a glass material or other transparent materials. The transparent material has a flat surface and is covered with an indium tin oxide (ITO) electrically-conductive film 3-1. An electrode for applying an external voltage is formed. Periodic nano-structures 3 are manufactured on the electrically-conductive film. Nano-structure units are made of one of a metal material, a metal oxide material or a semiconductor material. Distribution of nano-structures is determined according to a property of a spectrum to be constructed. The nano-structures include nano-block distribution structures or nano-hole distribution structures with a certain length-width-height ratio. Transmission of a light source is controlled by the micro-nano filter, so that the required spectrum is obtained. A voltage is applied to the electrically-controlled phase-change material by the voltage control apparatus.

The reconstruction target is continuous in visible and infrared wavebands, and enters the micro-nano filter or structure. Voltages at two ends of a liquid crystal layer is changed, so that spatial arrangement of a liquid crystal molecules is adjusted. That is, due to a spatial refractive index distribution property of the liquid crystal material, magnetic dipole resonance and electric dipole resonance of the nano-structure are variable in a resonant element. Further, modulation amounts of an amplitude and a phase position of a light beam caused by a switch of the liquid crystal layer are changed. Since the resonance property of the nano-structure has wavelength dependence, a transmission spectral response of the device is changed in different states of a liquid crystal 2. Spectral information can be reconstructed by using transmission spectra of liquid crystals in different states. The disclosure can be used for ultraviolet light. However, the liquid crystal material has poor stability under the ultraviolet irradiation and high energy absorption. A non liquid crystal material and a material having a ultraviolet tuning function can be applied.

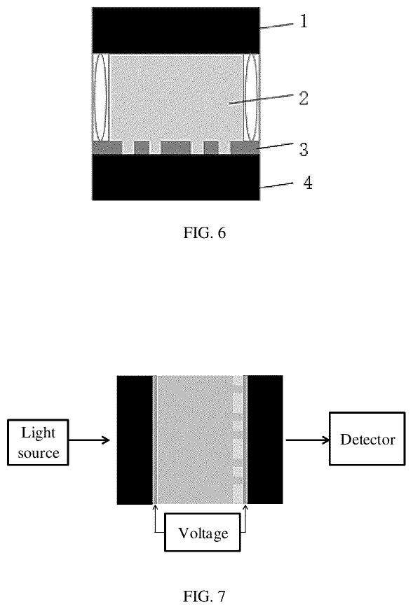

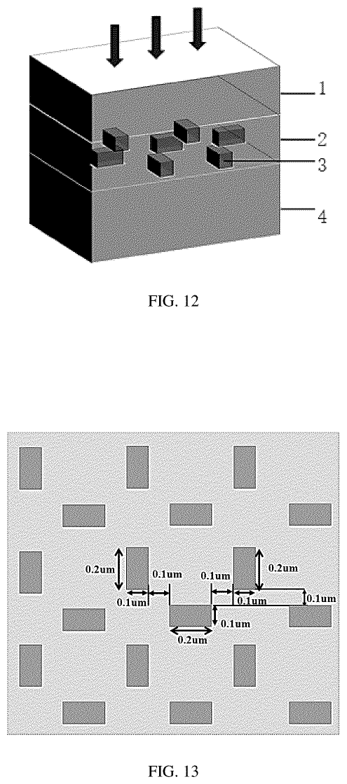

FIGS. 6, 12, etc. show a spectral filter based on nano-structures. The micro-nano filtering structure is connected to a power supply having an adjustable amplitude. Thus, the refractive index of the liquid crystal layer can be adjusted, and a filtering property of the device can be changed. The transmission spectrum of the micro-nano filtering structure is measured. The detector includes a charge-coupled device (CCD) or a complementary metal oxide semiconductor (CMOS). Filtering properties of the device in cases of different driving voltages, that is, different liquid crystal refractive indexes, are obtained.

Electrically-conductive films (other commercially-available transparent electrically-conductive films can be used) having ITO layers are arranged on surfaces of the cover plate 1 and the substrate 4. The cover plate and the substrate layer are made of a glass material or other transparent materials (such as quartz and polymethyl methacrylate (PMMA)). Electrically-conductive films refer to various electrically-conductive films such as ITO layers that match the substrate (through a physical plating or chemical vapor deposition (CVD) method). FIG. 12 shows a liquid crystal 2, and the nano-structures of the micro-nano filter, that is, nano-blocks or nano-holes 3. An electrically-conductive film 3-1 is arranged. Spectral information of a plurality of channels is constituted. The nano-blocks are formed by a staggered distribution of metal materials (or metal oxide materials or semiconductor materials). The nano-blocks each have a length of 200 nm, a width of 100 nm and a height of 250 nm. The structure is a particular instance. FIG. 13 is a top view of a micro-nano filtering structure.

The liquid crystal may be replaced with lithium niobate, germanium telluride, germanium antimony telluride, silver indium antimony telluride, antimony telluride or vanadium dioxide.

By changing the refractive index of the liquid crystal layer, the transmission spectrum of the micro-nano filtering structure is measured, and 32 groups of transmission spectra are obtained. Further, λ ∈ [a, b] ∈ [1200,1700] nm is enabled, sampling is carried out at an interval of 1 nm, a data dimension is 501 dimensions.

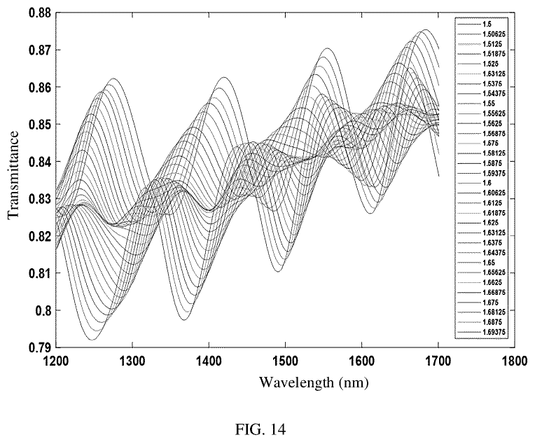

FIG. 14 shows a simulated transmittance curve of a micro-nano filtering structure in the example.

In FIG. 15, (a), (b), (c) and (d) show change curves of transmittance along with refractive indexes of a liquid crystal in cases of four different wavelengths (1300 nm, 1400 nm, 1500 nm and 1600 nm) respectively. The change curves of the transmittance along with the refractive indexes of the liquid crystal in cases of 1300 nm, 1400 nm, 1500 nm and 1600 nm are shown in FIG. 15. Light beams in different wavebands have different transmittance in cases of different refractive indexes of a liquid crystal.

After 32 groups of transmittance curves are obtained, a measurement value of an optical spectrometer based on filtration can be expressed as follows: D_{32×1}=S_{32×501}P_{501×1}.

Specifically, S is a matrix composed of transmittance curve groups, P denotes a spectrum of an incident light beam, and D is a measurement value of a detector corresponding to the filter.

The whole process of spectral reconstruction is displayed in the example. A number of filters required for a reconstruction input signal can be far less than a number of channels. The disclosure is superior to an existing spectrometer in a plurality of aspects such as hardware cost, system operation complexity, and spectrum resolution. It is expected that ideas are provided for achieving an intelligent and miniaturized optical spectrometer. In the disclosure, a transmission curvature property of the filter has a crucial influence on a spectral reconstruction result. The transmittance curve shall cover high-frequency and low-frequency information of a reconstruction signal.

Beneficial effects are as follows: compared with the prior art, the disclosure has advantages as follows:

Firstly, the disclosure provides a spectral reconstruction system based on a micro-nano filter or structure. The spectral reconstruction system is composed of a filtering structure, a voltage control system and a light intensity detector. A traditional method of using a chromatic dispersion element and a plurality of filtering plates is abandoned. Only one filtering structure is used. A spectrum is reconstructed by using different transmittance of light beams in different wavebands in cases of different refractive indexes of a liquid crystal. The structure of an optical system is extremely simplified, a size is small and weight is light.

Secondly, a spectral range is wide and a light utilization rate is high.

Thirdly, a filtering property is flexible. Nano-structures are self-controllable, and can be changed according to requirements of transmittance, etc., so that different filtering properties can be achieved.

Fourthly, during reconstruction, a magnitude of data is reduced, and a spectral acquisition speed is improved. Spectral reconstruction can be optimized by a neural network. Resolution and accuracy of spectral detection and imaging can be further improved.

In the technical solution of the disclosure, the core is to change the property of the filter by controlling the refractive index of a liquid crystal, etc. Thus, a transmittance curve of different wavebands passing through the filter are obtained. Spectral information is solved by using a pseudo-inverse method, etc. according to light-transmission information. Various properties of a material under different controlled conditions can be adjusted by using various tunable materials. Thus, transmittance information of light passing through the device is changed, and further the spectrum is reconstructed.

A key point of the technology is to change a light-splitting property of the filter by changing a parameter of the filter. A transmission curve of light is continuously and finely adjusted. The spectral information is computed by using a pseudo-inverse method. A pre-protection point lies in that the filter is manufactured by a tunable material. Transmittance of different wavebands after a continuous light source passes through a device is changed by controlling a condition. Thus, a solution is provided for miniaturization, high speed and accuracy of a spectral reconstruction system.

Various properties of a material under different controlled conditions can be adjusted by using various tunable materials. Thus, transmittance information of light passing through the device is changed, and further the spectrum is reconstructed. Besides the liquid crystal, graphene, lithium niobate, germanium antimony telluride and vanadium dioxide can also be used. Higher transmittance is better, and a larger phase change (refractive index change) range is better.

Continuous spectrum such as 400 nm to 1100 nm or 1100 nm to 1700 nm can be measured by the system in the disclosure. Moreover, a discontinuous spectrum having a plurality of narrowband peaks can also be measured. A spectrum can be constructed as long as measurement can be carried out.

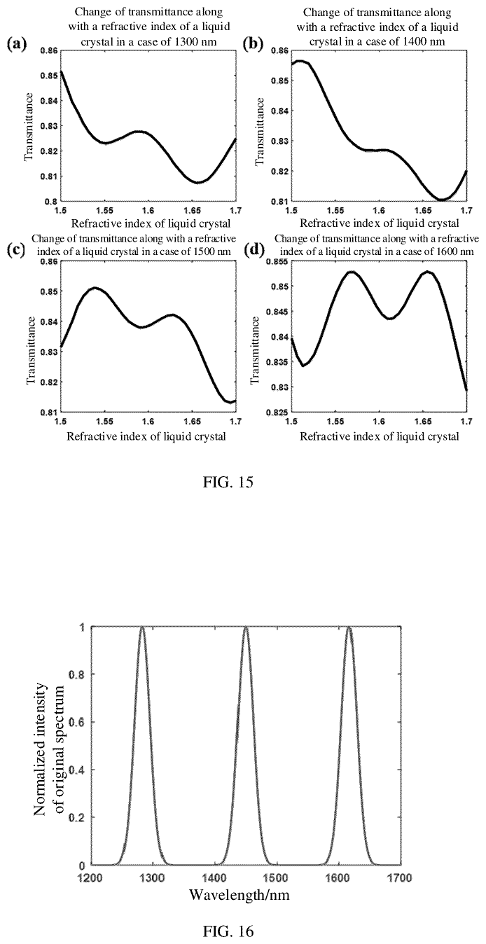

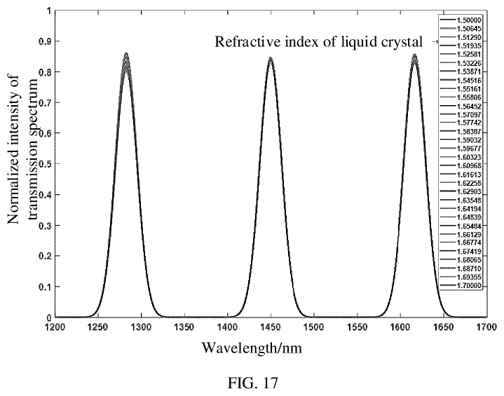

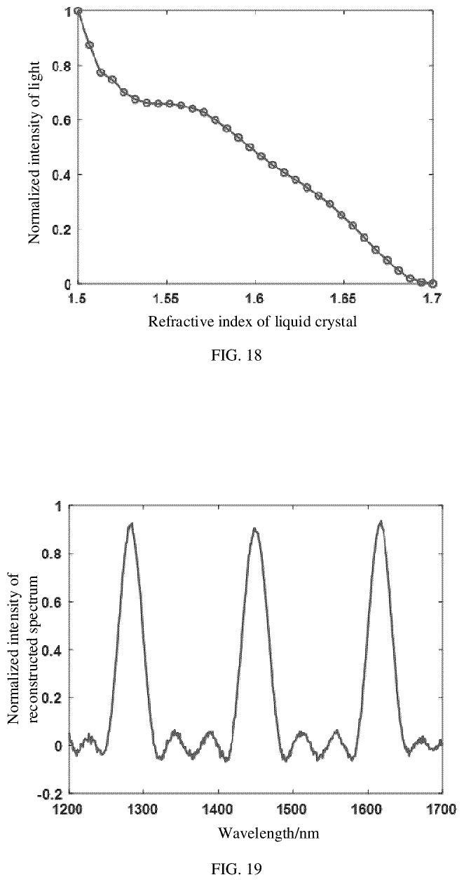

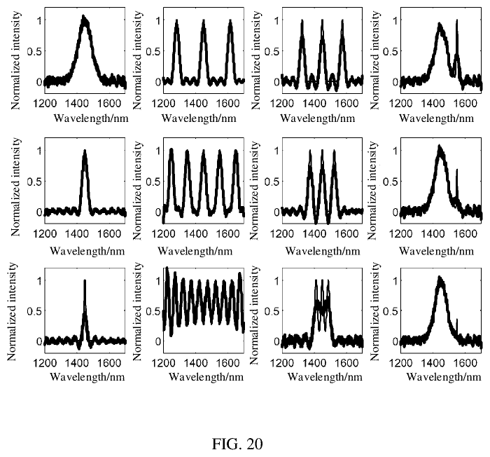

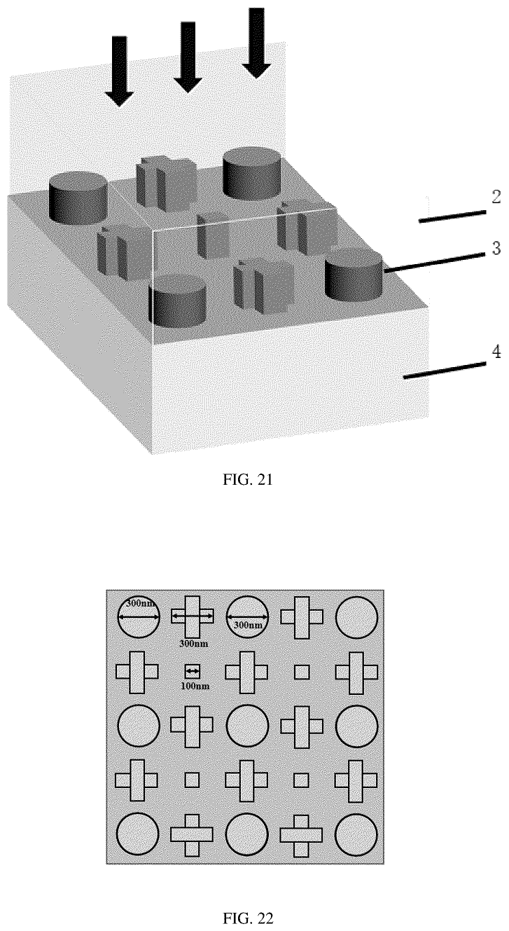

FIG. 16 shows an original spectrum to be reconstructed. FIG. 17 shows a transmission spectrum after the original spectrum passes through a micro-nano filtering structure shown in FIG. 12. FIG. 18 shows light intensity information after an original spectrum passes through a micro-nano filtering structure shown in FIG. 12. An incident light beam is reconstructed through a least squares method on the basis of the transmission spectrum and intensity information obtained. FIG. 19 is a diagram showing a pseudo-spectral reconstruction result in the example. FIG. 20 shows 12 groups of original spectra and spectra reconstructed through the above steps. Transmission light intensity of 16 or 32 types of liquid crystal passing devices (obtained channels) in cases of different refractive indexes is measured. Spectra of different channels are obtained. Detection spectral information can be restored. A number of channels when spectral information is restored can be much greater than 16 or 32. Moreover, 12 spectral images shown in FIG. 20 are merely instances. In order to demonstrate that the nano-structures and 16 or 32 channels given can be used to well reconstruct transmission light intensity of these 12 types of devices in cases of different wavelengths and different refractive indexes, different spectra having different spectral properties of different channels are obtained. However, the method is not limited to these 12 types of spectra. A spectrum in any morphology can be reconstructed in theory. When any one of these 12 types of spectra is reconstructed, the liquid crystal is required to be set in 16 or 32 different refractive index states. Data is separately collected, that is, 16 or 32 channels are collected. The spectrum is reconstructed.

In the reconstructed spectrum, for instance, in cases that a spectral range is 1200 nm to 1700 nm, and reconstruction resolution is 1 nm, the reconstructed spectrum cover 500 channels. In cases of different nano-structures, accuracy of the reconstructed spectra may be different.

Nano-structure units in the micro-nano filtering structure shown in FIG. 12 is formed by a staggered distribution of nano-blocks made of a metal material, a metal oxide material or a semiconductor material, or nano-blocks made of a metal material and a metal oxide material or a semiconductor material. The blocks made of a metal material, a metal oxide material or a semiconductor material each have a length of 200 nm and a width of 100 nm. The blocks made of a metal material, a metal oxide material or a semiconductor material of the micro-nano filtering structure may each have a thickness of 200 nm or 300 nm. The nano-block may be in a shape of a rectangle, a circle or a square.

Moreover, information of the micro-nano filtering structure is reflected by 32 groups of transmission spectra, and 32 groups of spectral information after transmission can be obtained after the original spectrum passes through 32 groups of transmission spectra. The original spectrum can be inverted from the spectral information. The reconstructed spectrum is obtained in this case. FIG. 20 shows 12 original spectra having different properties and spectra reconstructed through a least squares method from transmission spectral information after the original spectra pass through the micro-nano filtering structure.

Generally 3 periods or above of practical nano-structures arrays of the micro-nano filter may be available (practical nano-structures of three periods are shown in FIG. 13), and practical periods may be dozens to 100 or above. Examples: transmission light intensity of 16 or 32 types of (channels) of a liquid crystal in cases of different refractive indexes is measured. Spectra of different channels are obtained. Detected spectral information can be restored. A number of channels in the restored spectral information can be much greater than 16 or 32.

Distribution of the practical nano-structures of a material block is fixed. Micro-nano structures cannot be changed after being processed. A refractive index of a phase-change material is changed mainly. The refractive index generally changes within a range of 5% to 30%.

In FIGS. 16 to 20, FIG. 16 shows an original spectrum to be reconstructed. FIG. 17 shows a transmission spectrum after an original spectrum passes through a nano-block micro-nano filtering structure. FIG. 18 shows light intensity information after an original spectrum passes through a nano-block micro-nano filtering structure. FIG. 19 shows a reconstructed spectrum after light of an original spectrum passes through a nano-block micro-nano filtering structure. Thus, FIG. 20 shows results (that is, reconstructed spectrum curves) from 12 types of original spectra to reconstructed spectra (that is, 12 types of FIGS. 16 and 19). These 12 types have different spectral properties. A reconstruction effect of a micro-nano filtering structure on different spectra is reflected by a single peak, a plurality of peaks and a peak height. An arrow indicates a direction of a light source.

An incident light beam is reconstructed through a least squares method on the basis of the transmission spectrum and intensity information obtained. FIG. 19 is a diagram showing a pseudo-spectral reconstruction result in the example. FIG. 20 shows 12 groups of original spectra and spectra reconstructed through the above steps.

Spectral information is reconstructed on the basis of a plurality of groups of transmittance data. The method may be a least square method, a pseudo-inverse method, a neural network method, etc. Specific steps of reconstructing spectral information through the least squares method are as follows:

First, λ ∈ [a, b] is enabled. Sampling is carried out at intervals. After a group of transmittance curves are obtained, a measurement value of an optical spectrometer based on filtration can be expressed as follows: Ax=y.

Specifically, A is a matrix composed of transmittance curve groups, x denotes a spectrum of an incident light beam, and y is a measurement value of a detector corresponding to the filter.

$$A = [ \begin{matrix}t ( 1 , 1 ) & t ( 1 , 2 ) & ⋯ & t ( 1 , N ) \\ t ( 2 , 1 ) & t ( 2 , 2 ) & ⋯ & t ( 2 , N ) \\ ⋮ & ⋮ & ⋯ & ⋮ \\ t ( M , 1 ) & t ( M , 2 ) & ⋯ & t ( M , N )\end{matrix} ]$$

Incident light beam is reconstructed through a least squares method: x=(A^{T}A)⁻¹A^{T}y.

Particular instances are used for description below. A spectral reconstruction system is constructed by using a reconstruction or imaging target, a micro-nano filter or structure, a voltage control module and a detector as main units. As shown in FIG. 7, the light source is continuous in the infrared waveband and enters the micro-nano filtering structure, the voltages at two ends of the liquid crystal layer of the micro-nano filtering structure are adjusted, and then the refractive index of the liquid crystal is adjusted, so as to obtain the transmission spectral response of incident light passing through different filter structures, and the spectral information is reconstructed by using the incident light and the spectral response.

FIG. 7 is a spectral reconstruction system. FIG. 8 shows a micro-nano filtering structure. FIG. 9 is a top view of a micro-nano filtering structure. By changing the refractive index of the liquid crystal layer, the transmission spectrum of the micro-nano filtering structure is measured, so that 32 groups of transmission spectra are obtained. Further, λ ∈ [a, b] ∈ [1200,1700] nm is enabled. Sampling is carried out at an interval of 1 nm. A data dimension is 501 dimensions. FIG. 10 shows a simulated transmittance curve in the example.

After 32 groups of transmittance curves are obtained, a measurement value of an optical spectrometer based on filtration can be expressed as follows: Ax=y.

Specifically, A is a matrix composed of transmittance curve groups, x denotes a spectrum of an incident light beam, and y is a measurement value of a detector corresponding to the filter.

$$A = [ \begin{matrix}t ( 1 , 1 ) & t ( 1 , 2 ) & ⋯ & t ( 1 , 32 ) \\ t ( 2 , 1 ) & t ( 2 , 2 ) & ⋯ & t ( 2 , 32 ) \\ ⋮ & ⋮ & ⋯ & ⋮ \\ t ( 501 , 1 ) & t ( 501 , 2 ) & ⋯ & t ( 501 , 32 )\end{matrix} ]$$

An incident light beam (light source) is reconstructed through a least squares method as follows: x=(A^{T}A)⁻¹A^{T}y.

FIG. 14 shows a simulated transmittance curve, that is, a simulated spectral reconstruction result, of the device in FIG. 13 under continuous spectrum incidence conditions and in a case of control of the refractive index of the nano-block micro-nano filtering structure according to the disclosure.

The whole process of spectral reconstruction is displayed in the example. The disclosure is superior to an existing spectrometer in a plurality of aspects such as hardware cost, system operation complexity, and spectrum resolution. It is expected that ideas are provided for achieving an intelligent and miniaturized optical spectrometer. In the disclosure, a transmission curvature property of the micro-nano filter has a crucial influence on a spectral reconstruction result. The transmittance curve shall cover high-frequency and low-frequency information of a reconstruction signal.

A light source (that is, an input signal) is arranged in the system. The spectral property of the light source is unknown. The spectrum of the light source can be reconstructed through the micro-nano filter and the method in the disclosure. The spectrum of the light source can be continuous or discrete.

The number of filters required to reconstruct the light source can be much less than the number of channels. The number of channels should be understood as resolution of the reconstructed spectrum. Assuming that coverage of the spectrum of the light source is 1200 nm to 1700 nm, and resolution after reconstruction is 1 nm, the reconstructed spectrum has 501 channels. In theory, resolution of 1 nm (that is, 501 channels) is completely accurately achieved. The device in the disclosure is required to have 501 states. That is, the electrically-controlled phase-change material should be set at 501 different refractive indexes. Then, light energy transmitted through the device is separately measured. During actual use, 16 or 32 groups of data may be measured (that is, 16 or 32 channels are set for the micro-nano filter during measurement). Then, the spectrum can be reconstructed with resolution of 1 nm through some algorithms. Moreover, 501 channels are achieved. There are two concepts of the channel. One is a number of channels of a reconstructed spectrum. The other one is a number of actual working states generally set for the micro-nano filter in the disclosure during measurement (each working state corresponds to a test channel).

1. A device for establishing a spectrum, comprising a light source, a micro-nano filter and a voltage control apparatus, wherein the micro-nano filter comprises a substrate and a cover plate, and an electrically-conductive film layer and an electrically-controlled phase-change material are arranged between the substrate and the cover plate; the cover plate and the substrate are each made of a transparent material, and the transparent material has a flat surface and is covered with the electrically-conductive film layer comprising an indium tin oxide (ITO) layer, so that an electrode for applying external voltage is formed;
nano-structure units in a periodic array are manufactured on the electrically-conductive film layer, the nano-structure units are composed of a metal, a metal oxide or a semiconductor material, distribution of the nano-structure units is determined according to a property of a desired spectrum to be constructed, and the nano-structure units comprise nano-block distribution structures, optical grating distribution structures or nano-hole distribution structures with a certain length-width-height ratio; nano-block, optical grating or nano-hole units have dimensions on a subwavelength scale, and a transmission spectrum is regulated and controlled by interaction between the nano-structure units in the periodic array of the micro-nano filter and the electrically-controlled phase-change material; and
a voltage is applied to the electrically-controlled phase-change material by the voltage control apparatus;
wherein spectral information of a plurality of channels is controlled by the nano-structure units in the periodic array distributed on a flat surface of the electrically-conductive film layer of the micro-nano filter, and the plurality of channels herein mean that a transmission property of a continuous spectrum is controlled by the nano-structure units in the periodic array.

2. The device for establishing a spectrum according to claim 1, wherein the nano-blocks are composed or more of a metal, a metal oxide or a semiconductor material, and the nano-blocks have dimensions on a subwavelength scale.

3. The device for establishing a spectrum according to claim 2, wherein the metal material, the metal oxide material or the semiconductor material is gold, silver, aluminum, titanium dioxide, silicon nitride, gallium nitride, silicon, germanium or silicon dioxide, and shows low absorption in infrared and visible spectral ranges; the electrically-controlled phase-change material is liquid crystal, graphene, lithium niobate, germanium antimony telluride or vanadium dioxide; and the nano-blocks each have a length and a width each ranging from 100 nm to 1000 nm.

4. The device for establishing a spectrum according to claim 1, wherein the nano-structure units are formed by a staggered distribution of the nano-blocks made of the metal material, the metal oxide material or the semiconductor material, and the nano-blocks each have a length of 200 nm±50 nm, a width of 100 nm±30 nm and a thickness of 250 nm±100 nm.

5. The device for establishing a spectrum according to claim 1, wherein the nano-structure units in the periodic array of the micro-nano filter are distributed on a surface of the electrically-conductive film layer on one side corresponding to either of the substrate and the cover plate, or on two sides corresponding to both of the substrate and the cover plate; and the electrically-controlled phase-change material is in direct contact with the nano-structure units in the periodic array, and electrically-conductive layers on two sides of the electrically-controlled phase-change material are connected to an external voltage having an adjustable amplitude, and resonance of the micro-nano filter to light changes when the external voltage changes, so that a filtering property of the micro-nano filter is changed.

6. The device for establishing a spectrum according to claim 1, wherein the micro-nano filter is formed by stacking nano-structure materials with various periodicities, comprising nano-blocks having a high refractive index and nano-blocks having a low refractive index and distributed in a staggered manner, and the nano-blocks are made of different materials having largely different light transmission properties for light in the same waveband.

7. The device for establishing a spectrum according to claim 1, wherein distribution, hole structures and length-width-height ratio of the micro-nano filter are variable according to a required property; a hole array, an optical grating, a nano-column array or a nano-block array are comprised; and gold, silver, aluminum and titanium nitride are used in an infrared waveband, germanium and silicon dioxide are used in a visible waveband, and the nano-structure material and morphology of the micro-nano filter are selected according to a required waveband.

8. A method for establishing a spectrum by using the device according to claim 1, comprising: controlling a refractive index of liquid crystal by controlling a voltage between a substrate and a cover plate of a micro-nano filter, changing a property of the micro-nano filter according to distribution of nano-structures of the micro-nano filter, thereby obtaining a transmittance curve of different wavebands passing through the filter, and solving spectral information by using a pseudo-inverse method according to light-transmission information; changing an actual refractive index of the liquid crystal material by controlling an intensity of an applied electric field, changing a resonant frequency for a spectrum of a light source, thereby programmable-filtering the spectrum; and changing an actual refractive index of an electrically-controlled phase-change material by adjusting the voltage.

9. The method for establishing a spectrum according to claim 8, wherein, by means of the tunable electrically-controlled phase-change material, a property of the phase-change material under different controlled conditions is adjusted, transmittance of light passing through the device is changed, thereby the spectrum is reconstructed.

10. The method for establishing a spectrum according to claim 8, wherein the periodic nano-structures of the micro-nano filter serve as a resonant element, the resonant frequency thereof is related to a structural configuration and a refractive index of a structural material of the resonant element, and a transmission spectrum of light is determined by the resonant frequency.
